(19) United States
(12) Patent Application Publication
(10) Pub. No.: US 2006/0192486 A1
(43) Pub. Date: Aug. 31, 2006

(54) Electroluminescent phosphor, method for producing the same and device containing the same

(75) Inventor: Kyohei Ogawa, Minami-Ahigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD

(21) Appl. No.: 11/362,768

(22) Filed: Feb. 28, 2006

(30) Foreign Application Priority Data
Feb. 28, 2005 (JP) P. 2005-053415

(51) Int. Cl. H05B 33/00

(52) U.S. Cl. 313/509

(57) ABSTRACT

An electroluminescent phosphor comprising: ZnS-based phosphor particles and a coating layer provided on a surface of the particle, wherein the particles have an average particle size of from 0.1 to 20 μm, and a coefficient of variation in a particle size distribution of less than 35%, and a content of particles having 10 or more stacking faults with an interplanar spacing of 5 nm or less is 30% or more based on all of the ZnS-based phosphor particles.

### FIELD OF THE INVENTION

This invention relates to a ZnS-based electroluminescent (hereinafter sometimes referred to as “EL”) phosphor, a method of producing the same and an EL device containing the same.

### BACKGROUND OF THE INVENTION

EL devices are roughly divided into dispersion type EL devices wherein phosphor particles are dispersed in a dispersant and thin film EL devices wherein a thin phosphor film is inserted between dielectric layers. Dispersion type EL devices have the following characteristics, i.e., they are available in a constitution made up of flexible materials with the use of a plastic board without resorting to a high-temperature process, they can be produced by a relatively simple process at a low cost without using vacuum apparatus, the color of emitting light can be easily controlled by mixing phosphor particles of multiple types emitting lights of different colors, a relatively large area can be easily obtained and so on. Owing to these characteristics, attempts have been made to develop dispersion type EL devices as flat light sources. With the recent diversification in electronic devices, dispersion type EL devices are frequently employed as display materials for decorative purposes as well as image display devices.

It is known that EL devices suffer from the problem of lowering in brightness caused by moisture in EL phosphors. To prevent an EL phosphor from worsening, it has been a practice to form a coating layer made of a moisture-proof inorganic material on the surface of the EL phosphor as described in Japanese Patent No. 3187481, JP-A-11-204254, U.S. Pat. No. 5,643,496, JP-A-11-260557, JP-A-2002-226845, Japanese Patent No. 3286264 and JP-A-2002-124391. In the methods described in Japanese Patent No. 3187481 and JP-A-11-204254, however, there arises the problem that the luminous efficiency is lowered due to oxygen, steam, heat and so on in the step of forming a coating layer. On the other hand, U.S. Pat. No. 5,643,496, JP-A-11-260557, JP-A-2002-226845, Japanese Patent No. 3286264 and JP-A-2002-124391 indicate that the luminous efficiency is improved by coating. However, these methods are still insufficient for achieving both of a high brightness and a high luminous efficiency. Thus, it is impossible to achieve a high brightness and a high luminous efficiency by using these known techniques. Namely, these techniques are still insufficient for establishing a high brightness and such a high luminous efficiency as being available in practice.

### SUMMARY OF THE INVENTION

Accordingly, an object of the invention is to provide an EL phosphor achieving both of a high luminous efficiency and a high brightness and having a long life and a method of producing the same to thereby obtain an excellent EL device.

As the results of intensive studies, we have found out that both of the highest luminous efficiency and brightness can be achieved at high level by appropriately selecting the particle size (in particular, selecting a particle size range of from 15 to 20 μm), in the case of coated particles wherein gold and platinum are added and a large amount of copper is added as an activator to phosphor particles having a small coefficient of variation in the particle size distribution and a high stacking fault ratio. We have further found out that in an EL device containing these phosphor particles, both of the highest luminous efficiency and brightness can be achieved at high level by selecting a phosphor layer thickness range of from 40 μm to 100 μm.

Accordingly, the invention is as follows.

(1) An electroluminescent phosphor containing at least ZnS-based phosphor particles and a coating layer formed on the surface thereof, wherein the average particle size of the particles is from 0.1 to 20 μm, the coefficient of variation in the particle size distribution thereof is less than 35% and the content of particles having 10 or more stacking faults with interplanar spacings of 5 nm or less is 30% or more based on all particles.

(2) An electroluminescent phosphor as described in the above (1) wherein the average particle size of the particles is from 15 to 20 μm.

(3) An electroluminescent phosphor as described in the above (1) or (2) wherein the ratio of the average thickness of the coating layer to the average particle size of the particles is from 0.001 to 0.1.

(4) An electroluminescent phosphor as described in any one of the above (1) to (3) wherein the ZnS-based phosphor particles contain as an activator at least one element selected from the group consisting of Cu, Mn, Ag and rare earth elements.

(5) An electroluminescent phosphor as described in any one of the above (1) to (4) wherein the ZnS-based phosphor particles contain as a coactivator at least one element selected from the group consisting of Cl, Br, I and Al.

(6) An electroluminescent phosphor as described in any one of the above (1) to (5) wherein the ZnS-based phosphor particles contain as an additive at least one element selected from the group consisting of Au, Sb, Bi, Cs and Pt.

(7) An electroluminescent phosphor as described in any one of the above (1) to (6) wherein the ZnS-based phosphor particles contain 1×10⁻⁷ to 5×10⁻⁴ mol of Au per mol of ZnS.

(8) An electroluminescent phosphor as described in any one of the above (1) to (7) wherein the ZnS-based phosphor particles contain 1×10⁻⁷ to 1×10⁻³ mol of Pt per mol of ZnS.

(9) An electroluminescent phosphor as described in any one of the above (1) to (8) wherein the coating layer contains at least one compound selected from the group consisting of oxides, nitrides, hydroxides, fluorides, phosphates, diamond carbon and organic compounds.

(10) A method of producing an electroluminescent phosphor as described in any one of the above (1) to (9) which comprises while fluidizing the ZnS-based phosphor particles in the presence of a fluidization promoter having a larger average particle size than the average particle size of the particles, supplying the material of the coating layer thereto and thus piling up the material on the surface of the particles or reacting the material with the particles to thereby form the coating layer.

(11) A dispersion type electroluminescent device comprising a phosphor layer held between a pair of electrodes facing each other, at least one of which is transparent, and a dielectric layer wherein the phosphor layer contains an electroluminescent phosphor as described in any one of the above (1) to (9).

(12) A dispersion type electroluminescent device as described in the above (11) wherein the thickness of the phosphor layer is from 40 to 100 μm.

(13) A dispersion type electroluminescent device as described in the above (11) or (12) wherein at least one intermediate layer is provided between the transparent electrode and the phosphor layer.

(14) A dispersion type electroluminescent device as described in any one of the above (11) to (13) wherein the intermediate layer is made of an organic polymer compound, an inorganic compound or a complex thereof and the thickness of the intermediate layer is from 10 nm to 100 μm.

As the results of extensive studies, the inventors have found out that specific surface-coated phosphor particles, i.e., phosphor particles having a particle size falling within definite range (in particular, from 15 to 20 μm) and a small coefficient of variation thereof and having an inner structure with a large number of planar stacking faults exhibit extremely improved effects of achieving a high luminous efficiency, a high brightness and a long life. Moreover, it is found out that the effects of achieving a high luminous efficiency, a high brightness and a long life can be much improved by adding gold and by adding platinum.

Furthermore, it is found out that the effects of achieving a high luminous efficiency, a high brightness and a long life can be much improved by applying the phosphor particles as described above to an EL device having a phosphor layer thickness of from 40 to 100 μm. In particular, it is found out that the addition of gold and the addition of platinum bring about an increase in the luminous efficiency of coated phosphor particles having a particle size of from 15 to 20 μm. Accordingly, appropriate combination of these techniques highly efficiently contributes to an increase in the luminous efficiency and extension of the life as a whole.

In the invention, use is made of phosphor particles with a specific structure, i.e., phosphor particles having a small particle size and a small coefficient of variation and having an inner structure with a large number of planar stacking faults. Thus, these particles give EL light emission at an extremely high efficiency and a high brightness, though they have a coating layer. In the case of employed as an EL device, moreover, these phosphor particles can highly improve the durability of the EL device owing to the coating layer. This is seemingly because the deterioration of the phosphor and ion elution from the phosphor particles can be effectively prevented by the formation of the coating layer.

The EL phosphor of the invention, which has a small particle size and a narrow particle size distribution, shows a favorable dispersibility and can form an even phosphor layer. Thus, the coarseness (granularity) of the light emission can be remarkably improved, which makes it highly suitable for transmission photographs of high image qualities and inkjet transmission lighting.

As a method particularly suitable for the formation of a coating layer on such a small-sized EL phosphor, it is furthermore found out according to the invention that the coating can be highly efficiently formed at a high reproducibility without causing aggregation of the particles by fluidizing the EL phosphor under specific conditions with the use of a fluidization promoter.

In an EL device containing the EL phosphor of the invention, effects of preventing a transparent electrode from deterioration and further improving the durability of the EL device can be achieved by providing an intermediate layer between the transparent electrode and the phosphor layer. Even in the case of using an EL phosphor having a coating layer with poor ion-barrier properties, the effect of preventing the transparent electrode from deterioration can be obtained thereby.

### BRIEF DESCRIPTION OF THE DRAWINGS

FIG. 1 is a drawing schematically showing a fluidized bed reactor for producing the coated EL phosphor particles of the invention.

FIG. 2 is a drawing schematically showing an agitated bed reactor for producing the coated EL phosphor particles of the invention.

FIG. 3 is a drawing schematically showing a vibrated bed reactor for producing the coated EL phosphor particles of the invention.

FIG. 4 is a drawing schematically showing a rotated bed reactor for producing the coated EL phosphor particles of the invention.

FIG. 5 is a drawing schematically showing a liquid phase reactor for producing the coated EL phosphor particles of the invention.

FIG. 6 is a drawing schematically showing a compound particle-constructing apparatus for producing the coated EL phosphor particles of the invention.

FIG. 7 is a drawing schematically showing the cross section of the EL device of the invention.

### DESCRIPTION OF THE REFERENCE NUMERALS

| | |
|---|---|
| 52 | intermediate layer |
| 53 | phosphor layer |
| 54 | dielectric layer |
| 55 | transparent electrode layer |
| 56 | PET support |
| 57 | back electrode layer |
| 58 | moisture-proof film |

### DETAILED DESCRIPTION OF THE INVENTION

[EL Phosphor]

(ZnS-Based EL Phosphor Core Particles)

The ZnS-based phosphor particles to be used in the EL phosphor of the invention have an average particle size of from 0.1 to 20 μm, preferably from 15 to 20 μm. The coefficient of variation in the particle size distribution thereof is less than 35%, preferably less than 30%. Owing to these characteristics, the dispersibility of the EL phosphor particles and the filling rate of the EL phosphor particles in the phosphor layer can be elevated and the coarseness (granularity) of the light emission of an EL device can be improved.

Such EL phosphor core particles can be obtained by, for example, the following method.

As a precursor from which the ZnS-based phosphor particles are obtained, use may be made of marketed ZnS of a high purity. However, it is preferred to employ a precursor to which an activator has been uniformly added. To obtain such a precursor, use may be preferably made of the hydrothermal synthesis method, the homogeneous precipitation method or the spray thermal decomposition method. By any of these methods, a Zn salt and an activator salt, which are both dissolved in a solvent, are reacted together to form ZnS so as to give a precursor wherein the activator is incorporated into the ZnS. As the activator, it is preferable to use Cu, Mn, Ag or a rare earth element. It is more preferable to use Cu. The addition level of the activator varies depending on the activator type. For example, Cu may be added preferably in an amount of from 1×10⁻⁴ to 1×10⁻² mol per mol of ZnS, still preferably from 5×10⁻⁴ to 5×10⁻³ mol. In the case of using a precursor free from an activator, ZnS is dispersed in water and a water-soluble Cu compound (for example, CuSO₄, Cu(NO₃)₂ or the like) is added to the obtained suspension. Thus a precursor in which CuₓS has been deposited on the surface of ZnS particles is prepared. In this case, it is preferable to wash the suspension with distilled water several times after the completion of the reaction to thereby remove ZnSO₄ formed as a by-product.

As a coactivator, use can be made of Cl, Br, I and Al. It is preferable that the addition level of the coactivator is equivalent to that of the activator. Such a coactivator is introduced from a flux as will be described hereinafter. In the case of Al, however, it should be separately added in the form of, for example, Al(NO₃)₃.

In addition to the activator and the coactivator, it is preferable to add Au, Sb, Bi, Cs or Pt as an additive and the addition of Au is particularly preferred. It is assumed that the addition of Au prevents CuₓS crystals, from which electrons of the EL phosphor are generated, from deterioration. Thus, it is found out that the Au thus added effectively contributes to the improvement in the luminous efficiency and the extension of the life, together with the means of increasing the luminous efficiency, elevating the brightness and prolonging the life according to the invention. Particularly remarkable effects are observed in an EL phosphor which contains a large amount of Cu as the activator. The addition level of Au is preferably from 1×10⁻⁷ to 5×10⁻⁴ mol per mol of ZnS, still preferably from 5×10⁻⁷ to 1×10⁻⁴ mol.

By adding Pt, the luminous efficiency and the brightness can be furthermore elevated. It is preferable to add Pt to zinc sulfide in an amount of from 1×10⁻⁷ mol to 1×10⁻³ mol per mol of zinc sulfide, still preferably from 1×10⁻⁶ mol to 5×10⁻⁴ mol.

It is preferable that these metals are added together with a zinc sulfide powder and a definite amount of copper sulfate to deionized water, thoroughly mixed in the form of a slurry, then dried and baked together with a flux to thereby incorporate the metals into zinc sulfide particles. Alternatively, it is preferred that a powdery complex containing these metals is mixed with a flux and then baked with the use of the flux to thereby incorporate the metals into the zinc sulfide particles. In each case, an arbitrary compound containing the metal to be used can be employed as a starting compound for adding the metal. However, it is more preferable to employ a complex in which oxygen or nitrogen is coordinated with the metal or metal ion. As a ligand, either an inorganic compound or an organic compound may be used.

The EL phosphor may be baked by a solid phase reaction similar to the conventional methods. First, the precursor containing the activator is mixed with a flux also serving as a halogen coactivator source such as an alkali metal halide, an alkaline earth metal halide, an ammonium halide or zinc halide or an Al compound in the case of using Al as the coactivator. In the case of adding Cs as an additive, a Cs halide is further added and mixed. The mixing may be performed by dry-mixing in a mortar, a tumbler mixer or the like. Alternatively, distilled water may be once added to the mixture to give a suspension which is then dried to thereby give a more homogeneous mixture. The flux is added preferably in an amount of from 1 to 80% by mass based on ZnS, still preferably from 20 to 60% by mass. In the case where the flux is used in an excessively small amount, the crystal development cannot normally proceed in some cases. On the other hand, use of the flux in an excessively large amount results in the generation of a corrosive toxic gas. The mixture is packed in an alumina crucible and baked at a baking temperature of from 900 to 1200° C. To allow sufficient crystal development and even distribution of the activator in ZnS, the baking time preferably ranges from 30 minutes to 12 hours, still preferably from 1 to 6 hours. As the baking atmosphere, use can be made of an oxidative atmosphere such as air or oxygen, an inert atmosphere such as nitrogen or argon, a reductive atmosphere such as a hydrogen-nitrogen mixture or a carbon-oxygen mixture, or a sulfidizing atmosphere such as hydrogen sulfide or carbon disulfide.

After taking out the baked mixture from the crucible, it is preferable to sufficiently and repeatedly wash the baked mixture with an acid and water to thereby remove the excessive flux, by-products of the reaction, ZnO formed by the oxidization of ZnS and so on. The washed particles are then dried by using a vacuum dryer or the like so as to give an intermediate phosphor having a wurtzite crystal system.

It is preferable that a stress is applied to the baked intermediate phosphor and then re-baked to thereby increase the stacking fault density and elevate the brightness. To apply a stress on the phosphor particles, use may be made of a ball mill, ultrasonic wave, hydrostatic pressure or the like. It is preferable in any case to uniformly apply a load to the particles at such an extent as not breaking the phosphor particles. After applying the stress, the phosphor is re-baked at a temperature of from 500 to 900° C. In this step, it is favorable to add a compound of Sb or Bi, if needed, so as to prolong the life of the EL phosphor. The addition level thereof preferably ranges from 1×10⁻⁵ to 1×10⁻³ per mol of ZnS. Thus, most of the crystals are converted into the sphalerite structure. The re-baking may be carried out under the same conditions (baking time, atmosphere, etc.) as those employed in the baking.

By controlling the baking conditions and the like as described above, it is possible to obtain a ZnS-based EL phosphor having an average particle size of the from 0.1 to 20 μm, having a coefficient of variation in the particle size distribution of less than 35% and containing particles having 10 or more stacking faults with interplanar spacings of 5 nm or less in an amount of 30% or more based on all particles. However, the method of producing an ZnS-based EL phosphor is not restricted thereto. For example, an EL phosphor having a desired average particle size or particle size distribution can be obtained by preparing an EL phosphor having an average particle size exceeding 15 μm and then classifying the particles with the use of a dry sieve, a wet sieve, a gas cyclone, a liquid cyclone, a hydraulic elutriation or the like. It is also possible to obtain an EL phosphor having a desired average particle size or particle size distribution by preparing an EL phosphor having an average particle size exceeding 15 μm and then grinding the particles by using a mortar, a ball mill, a jet mill or the like.

(Formation of Coating Layer)

The EL phosphor of the invention is obtained by forming a coating layer on the surface of the core particles of the EL phosphor. The average thickness of the coating layer is preferably from 0.01 to 1 μm, still preferably from 0.05 to 0.5 μm. The term “average thickness of the coating layer” means the value determined by selecting at least ten particles from the cross-sectional SEM image of EL phosphor particles having the coating layer formed thereon, measuring the thickness of the coating layer at arbitrary three points per particles and calculating the mean.

So long as the average thickness of the coating layer falls within the range as defined above, a favorable moisture-proofness and ion-barrier properties can be obtained. It is also favorable that a lowering in the brightness and an increase in the threshold voltage for light emission are scarcely induced thereby without decreasing the electrical field intensity of the EL phosphor particles.

It is also preferable that the coating layer has a thickness suitable for the average particle size. In the case of forming a coating layer of 1 μm on particles of 1 μm in size, for example, a lowering in the electrical field intensity of the particles is scarcely induced. That is to say, the ratio of the average thickness of the coating layer to the average particle size of the particles is preferably from 0.001 to 0.1, still preferably from 0.002 to 0.05.

Although the composition of the coating layer is not particularly restricted, it is possible to employ an oxide, a nitride, a hydroxide, a fluoride, a phosphate, diamond carbon or an organic compound therefor. It is also preferable to employ a mixture thereof, mixed crystals, a multilayer film and so on. More specifically speaking, use can be preferably made of SiO₂, Al₂O₃, TiO₂, ZrO₂, HfO₂, Ta₂O₅, Y₂O₃, La₂O₃, CeO₂, BaTiO₃, SrTiO₃, PZT, Si₃N₄, AlN, Al (OH)₃, MgF₂, CaF₂, Mg₃(PO₄)₂, Ca₃(PO₄)₂, Sr₃(PO₄)₂, Ba₃(PO₄)₂, a fluororesin and so on. It is also preferable that the coating layer is free from pinholes or cracks and has a continuous structure.

The coating layer of the invention can be formed by, for example, the following method.

As a first method of forming a coating layer, a method comprising while fluidizing EL phosphor core particles, supplying the material of the coating layer thereto and thus piling up the material on the surface of the particles or reacting the material with the particles to thereby form the coating layer may be cited.

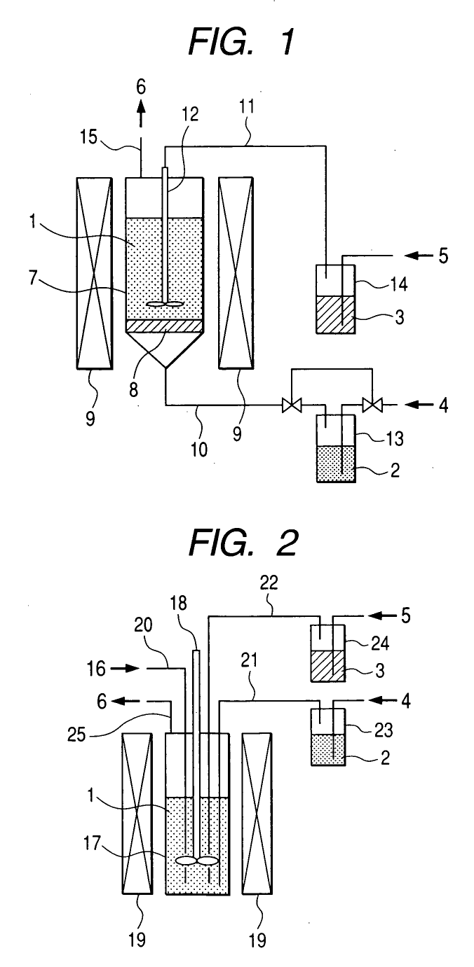

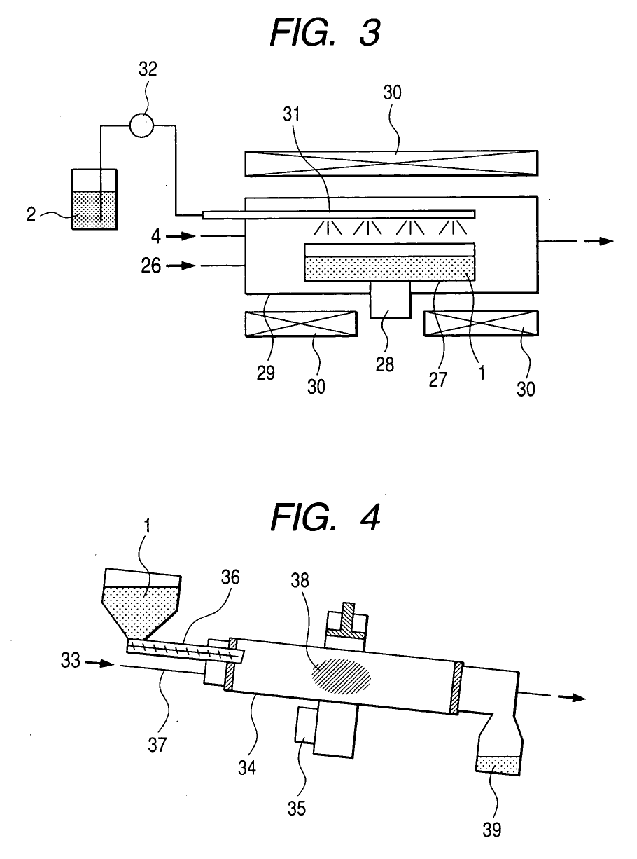

The EL phosphor core particles can be fluidized by using an appropriate known method. For example, it is possible to employ a method with the use of fluidized bed, an agitated bed, a vibrated bed or a rotated bed. In a fluidized bed, EL phosphor core particles are packed into a cylindrical container and then the suspended and fluidized by supplying a carrier gas from the bottom of the container via a porous plate, as shown in, for example, FIG. 1. In an agitated bed, EL phosphor core particles are packed and directly fluidized by using an impellar agitator or the like, as shown in, for example, FIG. 2. In a vibrated bed, EL phosphor core particles packed in a container are mechanically or electrically vibrated together with the container, as shown in, for example, FIG. 3. In a rotated bed, EL phosphor core particles are packed in a cylindrical container located horizontally or inclinedly and then rotating the container to thereby fluidize the particles, as shown in, for example, FIG. 4.

To obtain an even coating layer, it is particularly preferred to employ a fluidized bed. With a decrease in the particle size, the EL phosphor tends to aggregate and thus the fluidization becomes difficult. Therefore, it is favorable to add a fluidization promoter having a larger average particle size than the average particle size of the EL phosphor core particles. It is preferable that the fluidization promoter has a particle size 2 to 5 times larger than the average particle size of the EL phosphor core particles. As the fluidization promoter, it is preferable to employ a substance which is inert to the EL phosphor at the reaction temperature, for example, SiO₂, Al₂O₃, ZrO₂ or the like. It is also preferable that the fluidization promoter has a spherical shape whereby the highest fluidity can be established.

It is preferable to finally remove coarse particles or aggregated particles by using, for example, a dry sieve. Thus, it is possible to obtain a ZnS-based EL phosphor having an average particle size of from 0.1 to 20 μm, a coefficient of variation in the particle size distribution of less than 35% and contains particles having 10 or more stacking faults with interplanar spacings of 5 nm or less in an amount of 30% or more based on all particles.

By using the above method, a coating layer made of an oxide, a nitride, a hydroxide, diamond carbon, etc. can be formed. For example, a TiCl₄ solution is vaporized by bubbling N₂ gas thereinto and then reacted with the N₂ gas containing steam on the surface of EL phosphor core particles to form a TiO₂ precursor coating. An AlN coating can be formed by reacting an alkyl aluminum with anhydrous ammonia gas.

As a second method of forming a coating layer, a method comprising while dispersing EL phosphor core particles in a solvent, supplying the material of the coating layer thereto and thus piling up the material on the surface of the particles or reacting the material with the particles to thereby form the coating layer may be cited.

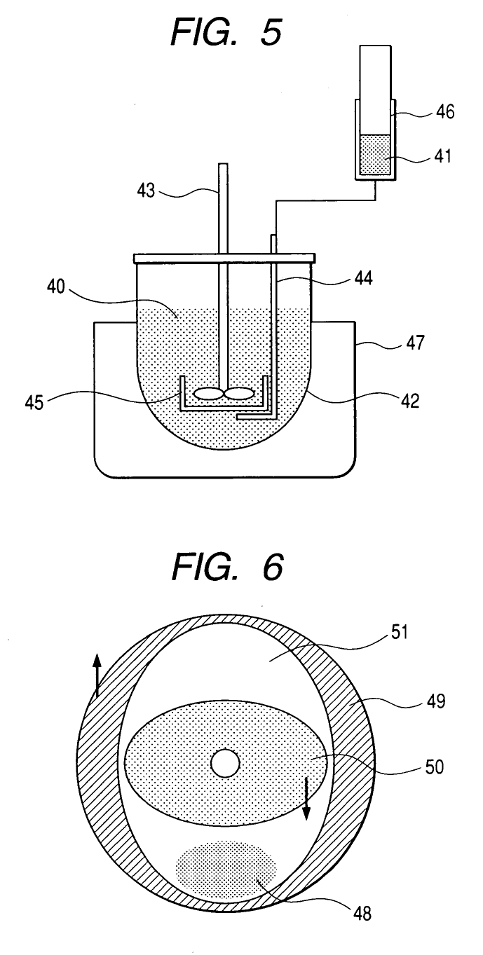

In this method, EL phosphor core particles can be introduced together with the solvent into a reactor and then dispersed by using an impellar agitator or the like. It is preferable that the reactor has a cylindrical shape with a conical or semispherical bottom. Agitating blades may be screw blades, twisted blades, paddles or the like. It is more preferable to employ screw-paddle blades whereby agitating streams in the circumferential direction of the agitation axis as well as in the perpendicular direction. As FIG. 5 shows, it is preferable to provide a strainer around the agitating blades so as to form a stronger agitation stream in the perpendicular direction. As the solvent, use can be preferably made of water, an organic solvent or a mixture thereof. As a specific solvent, it is also possible to use urea having been molted by heating to the melting temperature or above. Furthermore, it is preferable to add a dispersant such as a surfactant to the solvent.

To form the coating layer in the solvent, use can be preferable made of a method which comprises dissolving the coating layer material in a solvent wherein the EL phosphor core particles are dispersed and then adding a reaction solution thereto to thereby form the coating layer on the particle surface or a method which comprises simultaneously adding the coating layer material solution and the reaction solution to the solvent in which the EL phosphor core particles are dispersed. In such a case, it is preferable to add the coating layer material solution and the reaction solution into the region wherein agitation is carried out most vigorously. To add the coating layer material solution and the reaction solution, use can be made of a known proportioning pump or an orifice. It is favorable to use a syringe pump with little pulsation. In adding the coating layer material solution and the reaction solution, it is preferable to control the addition speeds of the individual solutions by detecting ion concentrations in the reactor. In the case of using urea etc. as the solvent, the reaction mixture is not restricted to liquid but solid materials may be added as such.

The reaction temperature can be controlled by directly heating the reactor with a mantle heater or the like. However, it is preferred to control the reaction temperature by providing a jacket around the reactor and feeding hot water or cold water thereto. In the case of using water or an organic solvent as the solvent, the reaction temperature preferably ranges from 40 to 80° C. In the case of using urea as the solvent, the reaction temperature preferably ranges from 130 to 150° C. Although the reactions having been discussed so far are to be carried out under atmospheric pressure, it is also preferable from the viewpoints of forming a dense coating layer or promoting the decomposition/condensation reaction to perform the reactions under elevated pressure with the use of an autoclave. In such a case, the reaction temperature exceeding 100° C. up to the critical temperature is usable. To add the solution into the autoclave, it is preferable to use a feeder pump tolerant to the pressure higher than the internal pressure of the autoclave.

A coating layer made of an oxide, a hydroxide, a phosphate, a fluoride or the like can be formed by the methods as discussed above. For example, a TiO₂ precursor coating can be formed on the surface of EL phosphor core particles by adding, as the reaction solution, about 10 equivalents of an alcohol-diluted water to a titanium alkoxide. An Mg₃(PO₄)₂ coating can be formed on the surface of EL phosphor core particles by dispersing the EL phosphor in an aqueous Na₃ (PO₄) solution and adding an aqueous MgCl₂ solution as the reaction solution. Also, an MgF₂ coating can be formed on the surface of EL phosphor core particles by dispersing the EL phosphor in an alcoholic Mg(CH₃COO)₂ solution and adding alcohol-diluted CF₃COOH as the reaction solution.

In the two methods of forming a coating layer as described above, it is also preferable to anneal the thus formed coating layer. In the case where a hydroxide is partly formed, it can be almost completely converted into the oxide by annealing. Furthermore, the denseness of the coating layer can be elevated thereby and, in its turn, the moisture-proofness and ion-barrier properties are improved.

As a third method of forming a coating layer, a method which comprises mixing EL phosphor core particles with the coating layer material and applying mechanical and thermal energy thereto to thereby form a coating layer can be cited.

Upon the application of the mechanical and thermal energy by impact or friction, the coating layer material can be solidified on the surface of the EL phosphor core particles. As an apparatus for applying the mechanical and thermal energy, use can be preferably made of a hybridizer, a seater composer, etc. Although an organic compound such as a polymer resin may be preferably used as the coating material, it is also possible to use an inorganic compound. It is also preferable to form an inorganic compound layer on a coating layer made of an organic compound to give a multilayer structure or form a coating layer made of a mixture of an organic compound with an inorganic compound.

[Fabrication of EL Device]

It is preferable to add the EL phosphor of the invention to the phosphor layer of an EL device. An EL device has a fundamental structure wherein a phosphor layer is held between a pair of electrodes facing each other and at least one of these electrodes is transparent, It preferably has an adjacent dielectric layer between the phosphor layer and an electrode. Also, it preferably has an intermediate layer between the transparent electrode and the phosphor layer.

As the phosphor layer, use can be made of a layer wherein the EL phosphor of the invention (the EL phosphor particles having the coating layer) is dispersed in a binder. As a binder, it is possible to use a polymer having a relatively high dielectric constant or a resin such as a polyethylene-, polypropylene- or polystyrene-based resin, a silicone resin, an epoxy resin or vinylidene fluoride. The dielectric constant can be controlled by adding fine particles having a high dielectric constant (for example, BaTiO₃ or SrTiO₃) to the binder in an amount of from 5 to 100 parts by mass per 100 parts by mass of the binder. To disperse, use can be made of a homogenizer, a sun-and-planet blender, a roll blender, an ultrasonic disperser or the like.

The phosphor layer can be formed by applying a coating solution containing EL phosphor particles. The coating solution containing EL phosphor particles is a coating solution which contains at least EL phosphor particles, a binder and a solvent in which the binder is soluble. As the solvent, use may be made of acetone, MEK, DMF, butyl acetate, acetonitrile, etc. it is preferable that the viscosity of the coating solution containing EL phosphor particles at room temperature is not lower than 0.1 Pa·s but not higher than S Pa·s, still preferably not lower than 0.3 Pa·s or higher but not higher than 1.0 Pa·s. When the viscosity of the coating solution containing EL phosphor particles is excessively low, the coating film frequently becomes uneven and the EL phosphor particles are sometimes separated and sedimented with the passage of time after the dispersion. When the viscosity of the coating solution containing EL phosphor particles is excessively high, on the other hand, coating can be hardly performed at a relatively high speed in some cases. Accordingly, it is favorable to control the viscosity within the range as defined above. The term “viscosity” as used herein means a value measured at 16° C., i.e., being the same as the coating temperature.

It is preferable that the phosphor layer of the EL device of the invention is formed by continuously coating on a plastic support provided with a transparent electrode or a laminate having a back electrode and a dielectric layer, which can be formed if necessary as will be discussed hereinafter, with the use of a slide coater, an extrusion coater, a doctor blade coater, etc. In this step, it is preferable to regulate the thickness variation of the phosphor layer to 12.5% or less, particularly 5% or less. From the viewpoint of achieving both of a high luminous efficiency and a high brightness, the thickness of the phosphor layer, in which the phosphor particles as described above are employed, preferably ranges from 40 μm to 100 μm, still preferably form 50 to 80 μm. By controlling the thickness of the phosphor layer as discussed above, the device can be operated at less power consumption to give the same brightness and, in its turn, heat generation accompanying light emission can be reduced. Thus, the EL device can be prevented from deterioration, thereby giving an EL device with a high durability.

Although the packing rate of the EL phosphor particles in the phosphor layer is not particularly restricted, it is preferably not less than 60% by mass but not more than 95% by mass, still preferably not less than 80% by mass but not more than 90% by mass. In the invention, the particle size of the EL phosphor particles is regulated to 20 μm or less so that the evenness in the thickness of the phosphor layer coating film is improved and the smoothness of the coating film surface is simultaneously improved. Further, the particle count per unit area can be largely elevated, which largely relieves fine unevenness in light emission.

It is preferred that the dispersion type EL device of the invention is provided with a dielectric layer in addition to the electrodes and the phosphor layer. The dielectric layer is preferably located between the phosphor layer and the back electrode adjacent to the phosphor layer. The dielectric layer can be formed by using any dielectric material so long as it has a high electric constant, high insulating properties and a high dielectric breakage voltage. Such a material is selected from among metal oxides and nitrides. For example, use can be made of TiO₂, BaTiO₃, SrTiO₃, PbTiO₃, KNbO₃, PbNbO₃, Ta₂O₃, BaTa₂O₆, LiTaO₃, Y₂O₃, Al₂O₃, ZrO₂, AlON, ZnS, etc. These materials may be provided as either a filmy crystal layer or a membrane having a particulate structure.

In the invention, the dielectric layer may be formed in one side of the phosphor layer. Alternatively, it is also preferable to form the dielectric layers in both sides of the phosphor layer. In the case of forming the dielectric layer by coating, use may be preferably made of a slide coater, an extrusion coater, a doctor blade coater, etc. as in the formation of the phosphor layer. In the case of a filmy crystal layer, it may be either a film formed by sputtering or a gas phase method such as vacuum vapor deposition or a sol-gel film formed with the use of an alkoxide of Ba or Sr. In this case, the thickness is usually ranges not less than 0.1 μm but not more than 10 μm. In the case of a particulate structure, it is preferable that the particle size is sufficiently small compared with the EL phosphor particle size. More specifically speaking, it is preferable that the particle size corresponds to 1/1000 to ⅓ of the EL phosphor particle size.

It is preferable to form the dielectric layer by applying a coating solution containing dielectric particles. The coating solution containing dielectric particles is a coating solution which contains at least dielectric particles, a binder and a solvent in which the binder is soluble. Examples of the binder are the same as those cited above as binders usable in the phosphor layer. As the solvent, use may be made of acetone, MEK, DMF, butyl acetate, acetonitrile, etc. it is preferable that the viscosity of the coating solution containing dielectric particles at room temperature is not lower than 0.1 Pa·s but not higher than 5 Pa·s, still preferably not lower than 0.3 Pa·s or higher but not higher than 1.0 Pa·s. When the viscosity of the coating solution containing dielectric particles is excessively low, the coating film frequently becomes uneven and the dielectric particles are sometimes separated and sedimented with the passage of time after the dispersion. When the viscosity of the coating solution containing dielectric particles is excessively high, on the other hand, coating can be hardly performed at a relatively high speed in some cases. Accordingly, it is favorable to control the viscosity within the range as defined above. The term “viscosity” as used herein means a value measured at 16° C., i.e., being the same as the coating temperature.

As the transparent electrode layer preferably usable in the EL device of the invention, use may be made of an electrode which is formed by using any material commonly employed in transparent electrodes. As examples of such a transparent electrode material, oxides such as ITO (indium tin oxide), ATO (antimony-doped tin oxide), ZTO (zinc-doped tin oxide), AZO (aluminum-doped zinc oxide) and GZO (gallium-doped zinc oxide), a multilayer structure comprising a silver film sandwiched between highly refractive layers, π-conjugated polymers such as polyaniline and polypyrrole, and so on may be cited. It is also favorable that such a transparent electrode layer is provided with metal wires of the comb or grid type to improve its electrical conductivity.

As the transparent electrode layer to be used in the EL device of the invention, use may be made of an electrode which is formed on one face of a transparent polymer film with the use of an arbitrary transparent electrode material. As the polymer film, PET, PAR, PES or the like may be used. The thickness of the polymer film is preferably from 20 to 200 μm, still preferably from 50 to 100 μm. It is preferable that the thickness variation is 10% or less based on the average thickness, still preferably 5% or less. Examples of the transparent electrode material include oxide films made of, for example, ITO (indium tin oxide), IZO (indium zinc oxide), ATO (antimony-doped tin oxide), ZTO (zinc-doped tin oxide), AZO (aluminum-doped zinc oxide), GZO (gallium-doped zinc oxide) and FTO (fluorine-doped tin oxide), coating films having an electrically conductive ink coating in which particles of such an oxide are dispersed in a polymer, a multilayered film comprising a silver film sandwiched between highly refractive layers, π-conjugated polymer films made of, for example, polyaniline and polypyrrole, and so on. It is preferable from the viewpoint of exhibiting a high brightness of an EL device that the surface resistivity of the transparent electrode layer is 300Ω/□ or less, still preferably 100Ω/□ or less and still preferably 30Ω/□ or less. Surface resistivity can be measured in accordance with the method specified in JIS K6911. The transmittance at 550 nm of the transparent electrode is preferably 70% or more, still preferably 80% or more and particularly preferably 90% or more. With an increase in the thickness of the transparent electrode layer, the surface resistivity is lowered and the light transmittance is also lowered. Taking the balance between the electrical conductivity and transmittance, therefore, the thickness of the transparent electrode layer is preferably from 5 to 500 nm, still preferably from 10 to 300=m.

It is also favorable that such a transparent electrode layer is provided with metal wires of the net, comb or grid type to improve its electrical conductivity and transparency. Although the transmittance is lowered by providing metal wires, the thickness of the transparent electrode layer can be reduced thereby. Namely, the transmittance can be improved exceeding the level of compensating the lowering by the metal wires, Concerning the metal wire material, use can be preferably made of copper, gold, silver, aluminum, nickel, an alloy containing the same or the like. A material having a high electrical conductivity and a high heat conductivity is preferred. The metal wire width is preferably from 0.1 to 1000 μm. It is preferable that these metal wires are located at intervals of from 50 μm to 5 cm, still preferably from 100 μm to 1 cm. The metal wire height (thickness) is preferably from 0.1 to 10 μm, still preferably from 0.5 to 5 μm. The metal wire width preferably corresponds to 1/10000 to 1/10 of the intervals among wires. Although the same applies to the wire height, it preferably corresponds to 1/100 to 10 times of the wire width. Either the metal wires or the transparent conductive film may serve as the surface. The smoothness of the conductive face is preferably 5 μm or less, still preferably from 0.05 to 3 μm. The smoothness of the conductive face means the average amplitude in the unevenness measured in a section (5 mm×5 mm) with the use of a three-dimensional surface roughness meter (for example, SURFCOM 575A-3DF manufactured by ACCRETECH). In the case where the analysis with the surface roughness meter is impossible, the smoothness is determined by observing under an STM or an electron microscope.

To prevent a lowering in voltage with an increase in the EL device area, it is preferable to form a bus electrode in the inner periphery on the transparent electrode layer with the use of a conductivity paste containing fine conductive particles of copper, gold, silver, carbon, etc. The bus electrode preferably has an area corresponding to 1% or more of the phosphor layer, still preferably 2% or more so as to efficiently supply power to the phosphor layer. Since the bus electrode area should be enlarged with an increase in the phosphor layer area, it is necessary to indicate the area ratio to the total area of the phosphor layer. The ratio of the bus electrode preferably area should be 1% or more to achieve a high brightness by reducing the phosphor layer thickness and elevating the operation voltage and the frequency. However, it is undesirable that the bus electrode area ratio exceeds 10%. This is because the performance of the EL device is not affected thereby but a non-light emitting member is unnecessarily increased or the device area is enlarged. To form the bus electrode, use can be made of the screen printing method or the casting method.

The back electrode layer, which corresponds to the side form which no light is taken out, may be formed by using an arbitrary material having electrical conductivity (a material commonly employed in forming back electrodes of this type). It may be formed by coating an electrically conductive paste comprising fine electrically conductive particles dispersed in a binder or bonding metallic materials such as copper, aluminum, gold, silver, etc. It is preferable that the metallic material to be bonded is in the form of a sheet. As a substitute for the metal sheet, use can be also made of a graphite sheet. The back electrode preferably has a heat conductivity of 100 W/m·K or above, still preferably 200 W/m·K or above.

In the case of forming both electrodes by the coating method, the coating can be carried out with the use of a slide coater, an extrusion coater, a doctor blade coater or the like as described above.

It is preferable that the EL device of the invention has at least one intermediate layer between the transparent electrode layer and the phosphor layer. The intermediate layer may be made of an organic polymer compound, an inorganic compound or a complex thereof. It is preferable that the EL device has at least one layer containing an organic polymer compound. The thickness of the intermediate layer is preferably from 10 nm to 100 μm, still preferably 100 nm or more but not more than 30 μm and particularly preferably 0.5 μm or more but not more than 10 μm.

In the case of using an organic polymer compound as a material for forming the intermediate layer, examples of the polymer compound usable therefor include polyethylene, polypropylene, polystyrene, polyesters, polycarbonates, polyamdies, polyether sulfones, polyvinyl alcohol, polysaccharides such as pullulan, saccharose and cellulose, vinyl chloride, fluorinated rubber, polyacrylates, polymethacrylates, polyacrylic amides, polymethacrylic amides, silicone resin, cyanoethylpullulan, cyanoethyl polyvinyl alcohol, cyanoethylsaccharose, UV-curable resins obtained from polyfunctional acrylate compounds, heat-curable resins obtained from epoxy compounds or cyanate compounds and so on. The polymer compound to be used herein may be either an electrically insulating material or an electrically conductive material.

Such an organic polymer compound or its precursor may be dissolved in an appropriate organic solvent and then coating on the transparent electrode or the phosphor layer to form the intermediate layer. In this case, it is preferable to carry out the coating with the use of a slide coater, an extrusion coater, a doctor blade coater or the like as described above. Examples of the organic solvent include dichloromethane, chloroform, acetone, methyl ethyl ketone, cyclohexanone, acetonitrile, dimethylformamide, dimethylacetamide, dimethyl sulfoxide, toluene, xylene and so on.

The intermediate layer may contain additives) for imparting various functions so long as it remains substantially transparent. The transmittance at 550 nm of the intermediate layer is preferably 70% or more, still preferably 80% or more. For example, it may contain a dielectric such as barium titanate particles, an electrically conductive material such as tin oxide, indium oxide, tin oxide-indium or metal particles, a dye, a fluorescent dye or a fluorescent pigment. Moreover, it may contain light-emitting particles to such an extent that the advantage of the invention is not damaged thereby (i.e. in an amount attaining not more than 30% of the brightness of the total electroluminescent phosphor).

The intermediate layer may be made of an inorganic compound such as SiO₂, another metal oxide or a metal nitride. To form the intermediate layer with the use of an inorganic compound, it is possible to employ the sputtering method, the CVD method, etc. In the case of forming the intermediate layer with the use of an inorganic compound, the thickness is preferably more than 10 nm but not more than 1 μm, still preferably more than 10 nm but not more than 200 nm. It is also favorable that the intermediate layer is composed of an inorganic compound layer and an organic polymer compound layer.

It is preferable that the EL device of the invention has at least one intermediate layer containing an organic polymer compound and having a thickness of 0.5 μm or more but not more than 10 μm. It is preferable that the organic polymer compound is one selected from among polyesters, polycarbonates, polyamdies, polyether sulfones, fluorinated rubbers, polyacrylates, polymethacrylates, polyacrylic amides, polymethacrylic amides, silicone resins, cyanoethylpullulan, cyanoethyl polyvinyl alcohol, cyanoethylsaccharose, UV-curable resins obtained from polyfunctional acrylate compounds and heat-curable resins obtained from epoxy compounds or cyanate compounds and so on. Among these compounds, one having a softening point of 70° C. or above (still preferably 100° C. or above) is preferred. It is also preferable to use a combination of two or more polymer compounds selected from those cited above.

In the case where the organic polymer compound employed in the intermediate layer has a high softening point (for example, 200° C. or above), it is also preferred to use another intermediate layer containing an organic polymer compound having a lower softening point so as to improve the adhesiveness to the transparent electrode layer of the phosphor particle-containing layer.

To achieve white light emission, a red light-emitting material is employed together with bluish green light-emitting zinc sulfide particles in the electroluminescent device of the invention. The red light-emitting material may be dispersed in the phosphor particle layer. Alternatively, it may be dispersed in the dielectric layer. It may be provided either between the phosphor particle layer and the transparent electrode or in the opposite side to the phosphor particle layer concerning the transparent electrode.

In the electroluminescent device of the invention, the light emission wavelength in emitting white light is preferably 600 nm or more but not more than 650 nm. To obtain red light wavelength falling within this range, the red light-emitting material may be contained in the phosphor particle layer, or provided between the phosphor particle layer and the transparent electrode or in the opposite side to the phosphor particle layer concerning the transparent electrode. It is most preferable that the red light-emitting material is contained in the dielectric layer. Although it is preferable that the whole dielectric layer in the electroluminescent device of the invention serves a dielectric layer containing the red light-emitting material, it is more preferable that the dielectric layer in the device is divided in two or more layers and a part thereof serves as a layer containing the red light-emitting material. It is preferable that the layer containing the red light-emitting material is provided between the dielectric layer and the phosphor particle layer. It is also preferred that the layer containing the red light-emitting material is sandwiched between dielectric layers free from the red light-emitting material. In the case where the layer containing the red light-emitting material is located between the dielectric layer free from the red light-emitting material and the phosphor particle layer, the thickness of the layer the red light-emitting material is preferably 1 μm or more but not more than 20 μm, still preferably 3 μm or more but not more than 17 μm. The concentration of the red light-emitting material in the dielectric layer containing the red light-emitting material is preferably 1% by weight or more but not more than 20% by weight, still preferably 3% by weight or more but not more than 15% by weight, based on the dielectric particles. In the case where the layer containing the red light-emitting material is sandwiched between dielectric layers free from the red light-emitting material, the thickness of the layer containing that the layer containing the red light-emitting material is preferably 1 μm or more but not more than 20 μm, still preferably 3 μm or more but not more than 10 μm. The concentration of the red light-emitting material in the dielectric layer containing the red light-emitting material is preferably 1% by weight or more but not more than 30% by weight, still preferably 3% by weight or more but not more than 20% by weight, based on the dielectric particles. In the case where the layer containing the red light-emitting material is sandwiched between dielectric layers free from the red light-emitting material, it is also preferable that the layer containing the red light-emitting material is free from dielectric particles but composed exclusively of a highly dielectric binder and the red light-emitting material.

The light emission wavelength of the red light-emitting material to be used herein in the form of a powder is preferably 600 nm or more but not more than 750 nm, still preferably 610 nm or more but not more than 650 nm and most preferably 610 nm or more but not more than 630 nm. This light-emitting material is added to the electroluminescent device. The red light emission wavelength at the electroluminescent light emission is preferably 600 nm or more but not more than 650 nm, still preferably 605 nm or more but not more than 630 nm and most preferably 608 nm or more but not more than 620 nm.

When such a red light-emitting material layer is formed in the dielectric layer, the total thickness of the dielectric layer is preferably 5 μm or more but not more than 40 μm, still preferably 10 μm or more but not more than 35 μm. The dielectric particles to be used in the dielectric layer containing the red light-emitting material can be selected from the same particles as in the dielectric layer free from red light-emitting material. The dielectric layer particles in the layer containing the red light-emitting material may be either the same or different from the particles in the layer free from red light-emitting material. As a binder in the layer containing the red light-emitting material, it is preferable to employ a polymer having a relatively high dielectric constant such as a cyanoethyl cellulose-based resin or a resin such as polyethylene, polypropylene, a polystyrene-based resin, a silicone resin, an epoxy resin or vinylidene fluoride. To disperse the dielectric material, use may be preferably made of a homogenizer, a sun-and-planet blender, a roll blender, an ultrasonic disperser or the like.

As the red light-emitting material in the invention, use can be preferably made of a fluorescent pigment or a fluorescent dye. As a compound serving as the emission center, a compound having a rhodamine, lactone, xanthene, quinoline, benzothiazole, triethylindoline, perylene, triphenin or dicyanomethylene skeleton is preferred. It is also preferable to use a cyanine pigment, an azo dye, a polyphenylene vinylene-based polymer, a disilane oligoethienylene polymer, a ruthenium complex, a europium complex or an erbium complex. Either one or two or more of these compounds may be used. It is also possible to disperse such a compound in a polymer or the like before using.

It is preferable to continuously form each of the layers as discussed above at least from coating to drying. The drying step is divided into a constant-rate drying step wherein drying is performed until the coating film is dried and solidified and a decreasing drying step wherein the solvent remaining in the coating film is reduced. When the drying is effected at a high speed in the invention wherein each layer has a high binder content, the surface is exclusively dried and a convective flow arises in the coating film, thereby frequently causing the so-called Benard cell phenomenon. Furthermore, a rapid expansion of the solvent frequently results in blister troubles which seriously damage the evenness of the coating film. When the drying temperature is too low, on the other hand, the solvent remains in each layer, which affects the subsequent steps of fabricating an EL device such as the step of laminating a moisture-proof film. In the drying step, therefore, it is preferable that the constant-rate drying is slowly carried out and then the decreasing drying is carried out at a temperature sufficient for drying the solvent. To carry out the constant-rate drying slowly, it is preferable that a drying room in which the base runs into several zones is divided into several zones and the drying temperature is elevated stepwise after the completion of the coating.

In the dispersion type EL device of the invention, it is preferable that a sealing film is used in the final stage to eliminate the effects of humidity and oxygen from the external environment.

The water vapor transmission rate at 40° C.-90% RH, which is measured in accordance with the method as defined in JIS K7129, of the sealing film to be used for sealing the EL device is preferably 0.05 g/m²/day or less, still preferably 0.01 g/m²/day or less. It is also preferable that the oxygen transmission rate thereof at 40° C.-90% RH is 0.1 cm³/m²/day/atm or less, still preferably 0.01 cm³/m²/day/atm or less. As the sealing film, use may be preferably made of a laminated film composed of an organic film with an inorganic film.

It is preferable that the organic film is made of a polyethylene-based resin, a polypropylene-based resin, a polycarbonate-based resin, a polyvinyl alcohol-based resin, etc. A polyvinyl alcohol-based resin is particularly preferred therefor. Since a polyvinyl alcohol-based resin or the like has a hygroscopic nature, it is preferable to absolutely drying it by, for example, vacuum drying before using. Such a resin is shaped into a sheet by the coating method or the like and then the inorganic film is layered thereon by vapor deposition, sputtering, using the CVD method, etc. The inorganic film to be layered is preferably made of silicon oxide, silicon nitride, silicon oxynitride, silicon oxide/aluminum oxide, aluminum nitride and so on. Among all, silicon oxide is preferably employed therefor. To achieve a lower water vapor transmittance rate or a lower oxygen transmittance rate or to prevent the inorganic film from cracking caused by bending, etc., it is preferable to form a multilayer film by repeatedly forming organic films and inorganic films or bonding multiple organic films having inorganic films layered thereon via adhesive layers. The thickness of the organic film preferably ranges from 5 μm to 300 μm, still preferably from 10 μm to 200 μm. The thickness of the inorganic film preferably ranges from 10 nm to 300 nm, still preferably from 20 nm to 200 nm. The thickness of the layered sealing film preferably ranges from 30 μm to 1000 μm, still preferably from 50 μm to 300 μm.

In the case of sealing an EL cell with this sealing film, the EL cell may be sandwiched between two sealing film sheets followed by sealing the periphery. Alternatively, a single sealing film may be folded in half followed by sealing the overlapped part. The EL cell to be sealed with the sealing film may be separately fabricated. Alternatively, the EL cell may be formed directly on the sealing film. In this case, the film can serve as a substitute for the support. It is preferable to perform the sealing step in vacuo or in a dry atmosphere under dew-point control.

In addition those discussed above, it is also preferable that the EL device has a cushioning material layer made of, for example, a polymer material having an excellent shock-absorbing function or a foamed polymer material containing a foaming agent for preventing oscillation, a compensation electrode layer facing the transparent electrode layer or the back electrode layer across an insulating layer, and so on.

The EL device of the invention can be fabricated by using any of the following methods. Namely, use may be preferably made of a method comprising bonding a laminate, which has been formed by successively coating a dielectric layer and a phosphor layer on a back electrode layer such as an aluminum foil, to a transparent electrode layer; a method comprising bonding a laminate, which has been formed by successively coating a phosphor layer and a dielectric layer on a transparent electrode layer, to a back electrode layer; a method comprising bonding a laminate, which has been formed by coating a phosphor layer on a transparent electrode layer, to another laminate, which has been formed by coating a dielectric layer on a back electrode layer; and so on. The bonding is preferably carried out by the heat compression bonding method with the use of a heat roller coated with a metal, a silicone resin, etc. The heat compression bonding temperature preferably ranges from 100 to 300° C., still preferably from 150 to 200° C. The heat compression bonding speed preferably ranges from 0.01 to 1 m/min, still preferably from 0.05 to 0.5 m/min. The heat compression bonding pressure preferably ranges from 0.01 to 1 MPa/m², still preferably from 0.05 to 0.5 MPa/m². When the heat compression bonding temperature or pressure is too low, a sufficient adhesion strength cannot be achieved and thus there arises a tendency toward interlayer peeling. When the heat compression bonding temperature or pressure is too high, on the other hand, the phosphor layer or the dielectric layer is excessively rolled and thinned and there arises a tendency toward insulation breakdown. In this case, the deterioration in the binder contained in the phosphor layer or the dielectric layer due to the high temperature and the disruption of the EL phosphor particles due to the high pressure are also observed.

In the dispersion type EL device of the invention, it is preferable that a sealing film is used in the final stage to eliminate the effects of humidity and oxygen from the external environment.

The water vapor transmission rate at 40° C.-90% RH, which is measured in accordance with the method as defined in JIS K7129, of the sealing film to be used for sealing the EL device is preferably 0.1 g/m²/day or less, still preferably 0.05 g/m²/day or less and particularly preferably 0.01 g/m²/day or less. It is also preferable that the oxygen transmission rate thereof at 40° C.-90% RH is 0.1 cm³/m²/day/atm or less, still preferably 0.01 cm³/m²/day/atm or less. As the sealing film, use may be preferably made of a polytrifluoroethylene chloride resin or a laminated film composed of an organic film with an inorganic film.

In the case of using a laminate film as the sealing film, it is preferable that the organic film is made of a polyethylene-based resin, a polypropylene-based resin, a polycarbonate-based resin, a polyvinyl alcohol-based resin, etc. A polyvinyl alcohol-based resin is particularly preferred therefor. Since a polyvinyl alcohol-based resin or the like has a hygroscopic nature, it is preferable to absolutely drying it by, for example, vacuum drying before using. Such a resin is shaped into a sheet by the coating method or the like and then the inorganic film is layered thereon by vapor deposition, sputtering, using the CVD method, etc. The inorganic film to be layered is preferably made of silicon oxide, silicon nitride, silicon oxynitride, silicon oxide/aluminum oxide, aluminum nitride and so on. Among all, silicon oxide is preferably employed therefor. To achieve a lower water vapor transmittance rate or a lower oxygen transmittance rate or to prevent the inorganic film from cracking caused by bending, etc., it is preferable to form a multilayer film by repeatedly forming organic films and inorganic films or bonding multiple organic films having inorganic films layered thereon via adhesive layers. The thickness of the organic film preferably ranges from 5 μm to 300 μm, still preferably from 10 μm to 200 μm. The thickness of the inorganic film preferably ranges from 10 nm to 300 nm, still preferably from 20 nm to 200 nm. The thickness of the layered sealing film preferably ranges from 30 μm to 1000 μm, still preferably from 50 μm to 300 μm.

A hot-melt adhesive is applied to one face of the sealing film. In the case of sealing an EL cell with this sealing film, the EL cell may be sandwiched between two sealing film sheets followed by heat compression bonding. Alternatively, a single sealing film may be folded in half followed by heat compression bonding. In the heat compression bonding, it is preferable to use a heat roller as described above, a press type heat compression bonding machine, etc. The heat compression bonding temperature preferably ranges from 100 to 200° C. The EL cell to be sealed with the sealing film may be separately fabricated. Alternatively, the EL cell may be formed directly on the sealing film. In this case, the film can serve as a substitute for the support. It is preferable to perform the sealing step in vacuo or in a dry atmosphere under dew-point control. In the case of sealing in vacuo, the pressure is preferably 10⁻² Pa or below.

In addition those discussed above, it is also preferable that the EL device has a cushioning material layer made of, for example, a polymer material having an excellent shock-absorbing function or a foamed polymer material containing a foaming agent for preventing oscillation, a compensation electrode layer facing the transparent electrode layer or the back electrode layer across an insulating layer, and so on. To effectively eliminate the heat generated from the EL device by driving, it is also preferable to provide a radiating sheet having a ceramic material dispersed therein. Moreover, it is preferable to provide an ultraviolet ray-absorbing layer to prevent UV-induced color change in the fluorescent pigment contained in an image sheet as will be discussed hereinafter or the EL device, or an electromagnetic wave-absorbing layer to prevent the release of electromagnetic wave from the EL device.

In general, an EL device is driven with the use of an AC source of 50 Hz to 400 Hz at 100 V. In an EL device having a small area, the brightness increases almost proportionally to the applied voltage and the frequency.

In an EL device having a large area of 0.25 m² or larger, however, the capacity component of the EL device is increased and thus there arises an impedance matching error between the EL device and the power source or the time constant required for the charge storage in the EL device is elevated. As a result, it is frequently observed that sufficient power cannot be supplied even under a high voltage or a high frequency. In the case of driving an EL device of 0.25 m² or larger with an AC source of 500 Hz or more, in particular, the applied voltage is frequently lowered with an increase in the driving frequency and, in its turn, the brightness is lowered. In contrast thereto, the EL device of the invention can be driven at a high frequency even in the case of having a large size of 0.25 m² or more to thereby achieve a high brightness. In such a case, the driving is preferably performed at 500 Hz to 5 KHz, still preferably 800 Hz to 3 KHz.

As examples of the application of the EL device of the invention, interior and exterior signs and displays may be cited. Image display systems with the combined use of the EL device with transfer imaging sheets such as color photo prints inkjet prints are particularly preferred. To ensure a favorable image visibility, the density of such a transfer imaging sheet preferably ranges from 1.5 to 4.5, still preferably from 2 to 3. The transfer imaging sheet is closely bonded to the light-emitting face of the EL device. The transfer imaging sheet may be bonded by using pressure, static electricity, etc. Alternatively, it may be detachably bonded to the EL device with an adhesive or the like. To elevate the whiteness in non-light emission, it is also preferable to provide a diffuser sheet, etc. between the image sheet and the EL device. Moreover, the surface of the image sheet may be provided with a protective sheet made of a resin. To ensure sufficient light resistance, impact resistance and transparency, it is preferable to use a resin such as an acrylic resin or a polycarbonate resin, which may be provided with an UV-absorbing layer, as the protective sheet. To ensure a sufficient rigidity and prevent the EL device from damages by a cutter knife or an edged metallic tool or electrical shock, it is preferable that the protective sheet has a thickness of form 1 to 10 mm, still preferably from 2 to 8 mm. It is preferable that an image display unit made up of the EL device, the image sheet and the protective layer is fixed to a fixing member comprising a fixing frame and a backboard made of aluminum, a resin, a wood material, etc. The EL device may be detachably fixed to the fixing frame or the backboard by using an adhesive or the like. Alternatively, it may be fixed by pressuring, etc. In the case of fixing to a curved face such as a column, it is preferable to use a fixing member having the same curvature as in the face to be fixed. From the viewpoint of space-saving, it is also preferred that the power source of the EL device is contained a room formed in the fixing member.

### EXAMPLES

To further illustrate the EL phosphors of the invention, methods of producing the same and EL devices in greater detail, the following EXAMPLES will be given. However, it is to be understood that the embodiments of the invention are not restricted to these EXAMPLES.

[Production of EL Phosphor Particles]

<EL Phosphor Particles A>

As a ZnS materials, ZnS having a crystallite size of 20 nm and an average particle size of 2 μm was prepared. A 25 g portion of this ZnS was weighed and fed together with 200 ml of distilled water into a 300 ml beaker. Then the mixture was stirred with a magnet stirrer until all ZnS particles were dispersed.

A 0.064 g portion of CsSO₄.5H₂O was weighed and dissolved in 2 ml of distilled water to give an aqueous solution. This solution was added to the dispersion of the ZnS particles as described above within about 30 seconds by using a burette. Stirring was continued for 30 minutes after the completion of the addition. After ceasing the stirring, the mixture was allowed to stand until the ZnS particles were sedimented. After the complete sedimentation of the ZnS particles, the supernatant was removed by decantation. Then 200 ml of distilled water was added for washing and the particles were redispersed by stirring. After stirring for 10 minutes, the ZnS particles were sedimented and the supernatant was removed by decantation. After repeating this washing procedure thrice, the particles were dried with a hot-air dryer at 120° C. for 4 hours to give ZnS containing Cu added thereto.

To the Cu-containing ZnS, the following flux and additives were added and mixed in a mortar t give a mixture.

| | |
|---|---|
| Cu-containing ZnS | 25 g |
| Sodium chloride | 0.5 g |
| Barium chloride dihydrate | 1.0 g |
| Magnesium chloride hexahydrate | 2.1 g |

This mixture was filled into an alumina crucible and covered. Then it was put in a Maffle oven at room temperature. The Maffle oven was heated at a speed of 800° C./h and then maintained at 1250° C. Thus, first baking was carried out in the atmosphere for 1 hour. After the completion of the first baking, the product was allowed to spontaneously cool to room temperature and then the alumina crucible was taken out. The firstly baked mixture was taken out from the alumina crucible, washed with 500 ml of a 0.1 M aqueous HCl solution, then washed with 500 ml of distilled water 5 times and dried with a hot air dryer at 120° C. for 4 hours. Thus, intermediate phosphor particles (ZnS:Cu, Cl) were obtained.

5 g of the intermediate phosphor particles and 20 g of alumina balls (1 mm) were packed in a glass bottle (diameter: 15 mm) and the particles were ball-milled at 10 rpm for 20 minutes. Then the alumina balls were separated from the intermediate phosphor particles by using a 100-mesh sieve. The intermediate phosphor particles thus separated were filled in an alumina crucible and covered. Then it was put in a Maffle oven at room temperature. The Maffle oven was heated at a speed of 400° C./h and then maintained at 700° C. Thus, second baking was carried out in the atmosphere for 4 hours. After the completion of the second baking, the product was allowed to cool to room temperature and then the alumina crucible was taken out. The secondly baked mixture was taken out from the alumina crucible, washed with 100 ml of a 10% aqueous KCN solution, then washed with 500 ml of distilled water 5 times and dried with a hot air dryer at 120° C. for 4 hours. Thus, EL phosphor particles A (ZnS:Cu,Cl) were obtained.

<EL Phosphor Particles B>

As in the EL phosphor particles A as described above, ZnS containing Cu added thereto was prepared.

To the Cu-containing ZnS, the following fluxes were added and mixed in a mortar t give a mixture.

| | |
|---|---|
| Cu-containing ZnS | 25 g |
| Strontium chloride hexahydrate | 27.3 g |
| Barium chloride dihydrate | 4.2 g |
| Magnesium chloride hexahydrate | 11.1 g |
| Chloroaurate tetrahydrate | 0.0053 g |

Subsequently, the procedures employed in producing the EL phosphor particles A were followed to give EL phosphor particles B (ZnS:Cu,Cl,Au).

<EL Phosphor Particles B′>

The procedures employed in producing the EL phosphor particles B were followed but not adding “chloroaurate tetrahydrate” to give EL phosphor particles B′ (ZnS;Cu,Cl).

<EL Phosphor Particles B″>

The procedures employed in producing the EL phosphor particles B were followed with adding not 0.0053 g but 0.1 g of “chloroaurate tetrahydrate” to give EL phosphor particles B″ (ZnS:Cu,Cl,Au).

<EL Phosphor Particles B1>

The procedures employed in producing the EL phosphor particles B were followed but not adding “chloroaurate tetrahydrate” but adding 17.5 Mg of Na₂[Pt(OH)₆] to “barium chloride dihydrate”, well mixing and then further mixing with the ZnS particles and other fluxes followed by baking the mixture, to give EL phosphor particles B3 (ZnS:Cu,Cl,Pt).

<EL Phosphor Particles B2>

The procedures employed in producing the EL phosphor particles B were followed but adding 17.5 mg of Na₂[Pt(OH)₆] to “barium chloride dihydrate”, well mixing and then further mixing with the ZnS particles and other fluxes followed by baking the mixture, to give EL phosphor particles B2 (ZnS:Cu,Cl,Au,Pt).

<EL Phosphor Particles C>

The procedures employed in producing the EL phosphor particles B′ were followed but adding 0.03 g of antimony trichloride to the intermediate phosphor particles of the EL phosphor particles B′ to give EL phosphor particles C (ZnS:Cu,Cl,Sb).

<EL Phosphor Particles D>

The procedures employed in producing the EL phosphor particles B′ were followed but adding 0.04 g of bismuth trichloride to the intermediate phosphor particles of the EL phosphor particles B, to give EL phosphor particles D (ZnS:Cu,Cl,Bi).

<EL Phosphor Particles E>

As in the EL phosphor particles A as described above, ZnS containing Cu added thereto was prepared.

To the Cu-containing ZnS, the following fluxes were added and mixed in a mortar t give a mixture.

| | |
|---|---|
| Cu-containing ZnS | 25 g |
| Strontium chloride hexahydrate | 27.3 g |
| Barium chloride dihydrate | 4.2 g |
| Magnesium chloride hexahydrate | 11.1 g |
| Cesium chloride | 4.5 g |

Subsequently, the procedures employed in producing the EL phosphor particles A were followed to give EL phosphor particles E (ZnS:Cu,Cl,Cs).

<EL Phosphor Particles F>

The procedures employed in producing the EL phosphor particles B were followed but adjusting the first baking temperature to 1100° C. to give EL phosphor particles F (ZnS:Cu, Cl).

<EL Phosphor Particles G>

The procedures employed in producing the EL phosphor particles A were followed but omitting the ball mill treatment of the intermediate phosphor particles to give EL phosphor particles G (ZnS:Cu,Cl).

[Evaluation of Particles]

The EL phosphor particles A to G were evaluated in the following items. Table 1 summarizes the results.

Average particle size (using the median diameter calculated by using LA-920 manufactured by HORIBA)

Coefficient of variation in particle size distribution (using the coefficient of variation calculated by using LA-920 manufactured by HORIBA)

Interplanar spacing in stacking fault (grinding phosphor particles in an agate mortar, observing fragments under a TEM, measuring the maximum interplanar spacings in stacking faults and counting sheets)

stacking fault frequency (observing 100 fragments obtained above under a TEM and measuring the frequency of stacking faults)

Phosphor composition analysis (quantifying Au and Pt by ICP-MAS)

As Table 1 indicates, the EL phosphor particles A to E each contained particles having 10 or more stacking faults with interplanar spacings of 5 nm or less in an amount of 50% or more, while the EL phosphor particles G had a large interlayer spacing and a frequency less than 30%.

TABLE 1

| | Average | Coefficient | Interplanar | | Stacking | Amount of Au | Amount of Pt |
|---|---|---|---|---|---|---|---|
| | particle | of | spacing in | No. of | fault | added | added |
| EL phosphor | size | variation | stacking | stacking | frequency | (mol/mol | (mol/mol |
| particle | (μm) | (%) | fault (nm) | faults | (%) | ZnS) | ZnS) |
| A | 24.5 | 42.0 | 4 | 10< | 65 | 0 | 0 |
| B | 17.7 | 34.0 | 4 | 10< | 80 | 2 × 10⁻⁶ | 0 |
| B′ | 17.3 | 33.2 | 4 | 10< | 78 | 0 | 0 |
| B″ | 17.6 | 33.8 | 4 | 10< | 77 | 6 × 10⁻⁴ | 0 |
| B1 | 17.4 | 33.6 | 4 | 10< | 81 | 0 | 2 × 10⁻⁵ |
| B2 | 17.2 | 33.1 | 4 | 10< | 79 | 2 × 10⁻⁶ | 2 × 10⁻⁵ |
| C | 17.2 | 33.5 | 4 | 10< | 76 | 0 | 0 |
| D | 16.7 | 33.7 | 4 | 10< | 71 | 0 | 0 |
| E | 16.0 | 33.8 | 4 | 10< | 78 | 0 | 0 |
| F | 8.7 | 31.9 | 4 | 10< | 60 | 2 × 10⁻⁶ | 0 |
| G | 17.9 | 34.2 | 8 | 10< | 25 | 0 | 0 |

[Formation of Coating Layer]
<Coated EL Phosphor Particles A to G>

Using the EL phosphor particles A to G, a coating layer made of TiO₂ was formed on the surface of the particles by using a fluidized bed reactor shown in FIG. 1. The fluidized bed reactor has a cylindrical reaction tank 7 provided with a perforated plate 8 at the bottom. The reaction tank is surrounded by a heater 9 and thus temperature-controlled. To the lower part of the perforated plate 9, a line 10 is connected for supplying a carrier gas for fluidizing the EL phosphor particles 1 and a gaseous coating layer material. A reaction gas inlet pipe 12, which is connected to a line for supplying a reaction gas, is provided close to the perforated plate in the reaction tank. These gas-supplying lines are also heated by the heater and provided, individually at the intermediate parts, with storage tanks 13 and 14 for vaporizing a coating layer material 2 and a reactant 3 respectively. The coating layer material 2 and the reactant 3 stored in the storage tanks are vaporized by bubbling with the carrier gases 4 and 5. The unreacted gases discharged from a reaction tank or the by-product gas 6 are discharged via an exhaust duct 15 connected to a scrubber (not shown).

100 g of each of the EL phosphor particles A to G were packed in the reaction tank of the fluidized bed reactor. In the case of the EL phosphor particles F, fluidization could not be sufficiently carried out by using the EL phosphor particles F alone. Thus, 50 g of spherical alumina particles having an average particle size of 25 μm were added as a fluidization promoter to 50 g of the EL phosphor particles F. As the coating layer material, a TiCl₄ solution kept at 35° C. was fed into the storage tank. As the reactant, distilled water kept at 30° C. was fed into the storage tank. As the carrier gas, Ar was fed via the perforated plate at a flow rate of 500 cc/min to thereby fluidize the EL phosphor particles. After heating the reaction tank to 200° C., bubbling of the TiCl₄ was initiated with the use of the Ar gas. At the same time, bubbling of the distilled water was also initiated with the use of the Ar gas. The Ar gas was supplied at a flow rate of 300 cc/min in both cases. After 2 hours, the gas supply was ceased and the reaction tank was cooled. Then the EL phosphor particles were collected to give coated EL phosphor particles A to G. Each of the EL phosphor particles thus collected had a TiO₂ coating layer having an average thickness of 150 nm on the surface.

<Coated EL Phosphor Particles b>

Using the EL phosphor particles B, the above procedures were followed but carrying out the bubbling not for 2 hours but for 10 minutes to thereby form a coating layer on the surface of the EL phosphor particles. Thus, coated EL phosphor particles b were obtained. The EL phosphor particles thus collected had a TiO₂ coating layer having an average thickness of 10 nm on the surface.

<Coated EL Phosphor Particles H>

Using the EL phosphor particles B, the above procedures were followed but replacing TiCl₄ in the coating layer A by trimethylaluminum and also replacing the reaction gas by O₂ to thereby form a coating layer on the surface of the EL phosphor particles. Thus, coated EL phosphor particles H were obtained. The EL phosphor particles thus collected had an Al₂O₃ coating layer having an average thickness of 170 nm on the surface.

<Coated EL Phosphor Particles I>

Using the EL phosphor particles Be the above procedures were followed but replacing TiCl₄ in the coating layer A by hexadimethylamide dialuminum and also replacing the reaction gas by NH₃ to thereby form a coating layer on the surface of the EL phosphor particles. Thus, coated EL phosphor particles I were obtained. The EL phosphor particles thus collected had an AlN coating layer having an average thickness of 110 nm on the surface.

<Coated EL Phosphor Particles J>

Using the EL phosphor particles B, a coating layer made of SiO₂ was formed on the surface of the particles by using an agitated bed reactor shown in FIG. 2. The agitated bed reactor has a cylindrical reaction tank 17 having an agitator 18 therein. The reaction tank is surrounded by a heater 19 and thus temperature-controlled. At the bottom of the reaction tank, lines 20, 21 and 22 respectively for supplying an auxiliary carrier gas for fluidizing the EL phosphor particles 1, a gaseous coating layer material and a reaction gas are attached. These gas-supplying lines are also heated by the heater and provided, individually at the intermediate parts, with storage tanks 23 and 24 for vaporizing a coating layer material 2 and a reactant 3 respectively. The coating layer material 2 and the reactant 3 stored in the storage tanks are vaporized by bubbling with the carrier gases 4 and 5. The unreacted gases discharged from a reaction tank or the by-product gas 6 are discharged via an exhaust duct 25 connected to a scrubber (not shown).

100 g of the EL phosphor particles B were packed in the reaction tank of the agitated bed reactor. As the coating layer material, an SiCl₄ solution kept at 35° C. was fed into the storage tank. As the reactant, distilled water kept at 30° C. was fed into the storage tank. As the auxiliary carrier gas, Ar was supplied through the auxiliary gas-supplying pipe at a flow rate of 200 cc/min and the paddle type agitator was rotated at 30 rpm to thereby fluidize the EL phosphor particles. After heating the reaction tank to 200° C., bubbling of the SiCl₄ was initiated with the use of the Ar gas. At the same time, bubbling of the distilled water was also initiated with the use of the Ar gas. The Ar gas was supplied at a flow rate of 300 cc/min in both cases. After 2 hours, the gas supply was ceased and the reaction tank was cooled. Then the EL phosphor particles were collected to give coated EL phosphor particles J. The EL phosphor particles thus collected had an SiO₂ coating layer having an average thickness of 100 nm on the surface.

<Coated EL Phosphor Particles K>

Using the EL phosphor particles B, a coating layer made of Ta₂O₃ was formed on the surface of the particles by using a vibrated bed reactor shown in FIG. 3. The vibrated bed reactor has a horizontally located phosphor-containing part 27 which is vibrated by a vibration generator 28 to thereby fluidize EL phosphor particles 1. The phosphor-containing part 27 is tightly closed by a reaction tank 29 and surrounded by a heater 30 and thus temperature-controlled. A coating layer material 2 is supplied in the form of a liquid from a coating material-supplying nozzle 31 by a feeder pump 32. Then the coating layer material reacts with a carrier gas 4 and a reaction gas 26 supplied from gas-supplying lines. The unreacted gases discharged from a reaction tank or the by-product gas 6 are discharged via an exhaust duct connected to a scrubber (not shown).

100 g of the EL phosphor particles a were packed in the phosphor-containing part of the vibrated bed reactor. By using an unbalance mass type vibrator, the phosphor-containing layer was vibrated at 1 KHz to thereby fluidize the EL phosphor particles. As the carrier gas, N₂ was supplied at a flow rate of 200 cc/min. After heating the reaction tank to 400° C., a 0.1 wt % ethanol solution of TaCl₅ was sprayed from the coating layer material-supplying nozzle onto the fluidized EL phosphor particles at a rate of 100 cc/min. After spraying for 10 minutes, the spraying was ceased and the particles were dried for 10 minutes. Next, the carrier gas was replaced by O₂ employed as the reaction gas which was supplied at 200 cc/min for 20 minutes. After repeating this procedure 10 times, the reaction tank was cooled and the EL phosphor particles were collected to give coated EL phosphor particles K. The EL phosphor particles thus collected had a Ta₂O₅ coating layer having an average thickness of 100 nm on the surface.

<Coated EL Phosphor Particles L>

Using the EL phosphor particles B, a coating layer made of diamond carbon was formed on the surface of the particles by using a rotated bed reactor as shown in FIG. 4. The rotated bed reactor is an apparatus constructed by modifying a so-called rotary kiln. A rotating quartz core tube 34 is located at an inclination of 1° based on the horizontal direction. A microwave generator 35 is provided adjacent to almost the center of the quartz core tube so as to allow microwave irradiation within the core tube. EL phosphor particles 1 are supplied from the top edge of the inclined tube with the use of a powder feeder 36. A coating layer material gas and a back pressure gas 33 are supplied from a supplying tube 37 located at the end in the same side of the EL phosphor particles. The other end is connected to a vacuum pump (not shown) to evacuate the inside of the core tube. With the rotation of the core tube, the EL phosphor particles supplied into the core tube are slowly transported downward and packed in a powder-collecting container 39 via a plasma generating area 38.

The EL phosphor particles were supplied into the core tube by using the powder feeder and the core tube was rotated at 10 rpm. While evacuating the inside of the core tube with the vacuum pump, a gas mixture (CH₄:H₂=1:99) was supplied as the coating material and the reaction gas so as to maintain the pressure in the core tube at 5000 Pa. By irradiating with a microwave (2.45 GHz) at 300 W generated from the microwave generator, plasma state was achieved in the inner space of the core tube and thus diamond carbon was formed on the surface of the EL phosphor particles. Thus, coated EL phosphor particles L were obtained. The EL phosphor particles thus collected had a diamond carbon coating layer having an average thickness of 50 nm on the surface.

<Coated EL Phosphor Particles M>

Using the EL phosphor particles B, a coating layer made of Mg₃ (Po₄)₂ was formed on the surface of the particles by using a liquid phase reactor as shown in FIG. 5. The liquid phase reactor has a cylindrical solution-packing part 42 having a semispherical bottom in which a mother reaction liquor is to be stored, an agitator 43 and at least one solution-supplying pipe 44. The agitating blades of the agitator, which are in the screw and paddle complex type, rotate so as to form an upward agitation flow. A strainer 45 is located around the agitator. The solution-supplying pipe is provided so that a solution is supplied to the bottom of the strainer thereby. The solution-supplying pipe is connected to a syringe pump 46 to thereby supply a reaction liquor 41. The solution-packing part is heated/cooled with a water jacket 47.

2.5 L of distilled water and 12.2 g of (NH₄)₃PO₄.3H₂O were poured into the solution-packing part and dissolved. To the obtained aqueous solution, 100 g of the EL phosphor particles B were added and suspended to give a mother reaction liquor. This mother reaction liquor was heated to 40° C. and agitated at 500 rpm. As a reaction solution, an aqueous solution was prepared by dissolving 18.3 g of MgCl₂.6H₂O in 100 ml of distilled water and packed in the syringe pump. By using the syringe pump, the reaction solution was added at a speed of 2 ml/min. After the completion of the addition of the reaction solution, the temperature of the suspension was elevated to 90° C. and the suspension was matured over 1 hour. When the maturation was completed, the suspension was cooled to room temperature and filtered under suction though a 5C filter paper to thereby separate the coated phosphor particles from the suspension. To the coated phosphor particles remaining on the funnel in the form of a cake, distilled water was added into the funnel thrice in 1 L portions and the cake was washed by filtering under suction. After filtering, the cake of the coated phosphor particles was vacuum dried by using a vacuum dryer at 120° C. for 4 hours. The coated phosphor particles thus dried were annealed in the atmosphere at 300° C. for 1 hour to give coated EL phosphor particles M. The coated EL phosphor particles had an Mg₃(PO₄)₂ coating layer having an average thickness of 200 nm on the surface.

<Coated EL Phosphor Particles N>

Using the EL phosphor particles B, a coating layer made of MgF₂ was formed on the surface of the particles by using the same liquid phase reactor as used in the coated EL phosphor particles M.

2.5 L of IPA and 7.0 g of Mg(CH₃COO)₂.4H₂O were poured into the solution-packing part and dissolved. To the obtained aqueous solution, 100 g of the EL phosphor particles B were added and suspended to give a mother reaction liquor. This mother reaction liquor was heated to 40° C. and agitated at 500 rpm. As a reaction solution, an aqueous solution was prepared by dissolving 12.5 ml of CF₃COOH in 87.5 ml of IPA and packed in the syringe pump. By using the syringe pump, the reaction solution was added at a speed of 2 ml/min. After the completion of the addition of the reaction solution, the suspension was matured over 2 hours. When the maturation was completed, the suspension was cooled to room temperature and filtered under suction though a 5C filter paper to thereby separate the coated phosphor particles from the suspension. To the coated phosphor particles remaining on the funnel in the form of a cake, distilled water was added into the funnel thrice in 1 L portions and the cake was washed by filtering under suction. After filtering, the cake of the coated phosphor particles was vacuum dried by using a vacuum dryer at 120° C. for 4 hours. The coated phosphor particles thus dried were annealed in the atmosphere at 300° C. for 1 hour to give coated EL phosphor particles N. The coated EL phosphor particles had an MgF₂ coating layer having an average thickness of 50 n=on the surface.

<Coated EL Phosphor Particle O>

Using the EL phosphor particle B, a coating layer made of ethylene tetrafluoride was formed on the surface of the particles by using a compound particle-constructing apparatus (a seater composer) as shown in FIG. 6. The compound particle-constructing apparatus has a rotor 49 having a large elliptic inner space combined with a small elliptic rotor 50 having a major axis somewhat shorter than the minor axis of the former rotor 49. These large and small rotors are concentrically located and rotate in the opposite directions to each other. A mixture of the EL phosphor particles and the coating material 48 is poured into the space 51 formed by the large and small rotors.

20 g of the EL phosphor particles B and 0.4 g of ethylene tetrafluoride particles having an average particle size of 2 μm (TFW-3000F manufactured by SEISHIN ENTERPRISE CO., LTD.) were poured into the seater composer. After rotating each rotor at 1000 rpm for 5 minutes, the EL phosphor particles were collected to give coated EL phosphor particles O. The coated EL phosphor particles had an ethylene tetrafluoride coating layer having an average thickness of 200 nm on the surface.

[Evaluation of Coated EL Phosphor Particles]

Thickness of coating layer (measuring from SEM sectional photographs).

Barrier properties (dipping in a 0.1 M AgNO₃ solution, observing a change in the body color and evaluating in 2 grades, i.e., A (no change after 24 hours) and B (darkened))

[Fabrication of EL Devices]

EL devices were fabricated by using the coated EL phosphor particles A to O obtained above and the EL phosphor particles A to G having no coating layer.

A transparent electrode film I having an ITO electrode with a surface resistivity of 100Ω/□ layered on a PET support (100 μm) was prepared. Next, a transparent electrode film II having an intermediate layer applied on the ITO electrode surface was prepared. In the transparent electrode film II, a layer of 1.5 μm in thickness was formed by dissolving polyester of bisphenol A and phthalic acid (terephthalic acid:isophthalic acid=1:1) (U-100: manufactured by UNITIKA) in dichloromethane and applying the solution (concentration 14%) by the dip-coating method.

Next, each EL phosphor, a Cyanoresin (CR-S: manufactured by SHIN-ETSU) employed as a binder and DMF as a solvent for dissolving the binder were prepared. The following composition was added to the organic solvent DMF and dispersed with a propeller mixer (rotational speed 3000 rpm) to give a coating solution containing the EL phosphor particles having a viscosity of 0.5 Pa·s at 16° C.

| | |
|---|---|
| EL phosphor | 100 parts by mass |
| Cyanoresin | 25 parts by mass |

The viscosity of each coating solution was measured by using viscometers (VISCONIC ELD.R and VISCOMETER CONTROLLER E-200 ROTOR No. 71: manufactured by Tokyo Keiki Co., Ltd.) under stirring (rotation speed: 20 rpm) at a liquid temperature of 16° C.

Next, a solution (concentration 35% by mass) was prepared by dissolving barium titanate (BT-8, average particle size 120 run: manufactured by Cabot Speciality Chemicals) employed as dielectric particles and a Cyanoresin (an equivalent mixture of CR-S with CR-V: manufactured by SHIN-ETSU) employed as a binder in DMF. The following composition was packed in a wide-mouthed bottle made of Teflon and dispersed on a rotational roller at 50 rpm for 30 minutes, Then, 280 parts by mass of zirconia particles having an average particle size of 2 mm were added thereto and the resultant mixture was dispersed for additional 30 minutes.

The obtained dispersion was dispersed in a mix rotor (consisting of parallel multiple discs made of alumina) for 2 hours. The rotational speed was 500 rpm at the initiation and then gradually elevated to 2000 rpm as the dispersion proceeded. To prevent the evaporation of the solvent, the dispersion was maintained at about 20° C. by ice-cooling around the pot. After dispersing, 120 parts by mass of a 35% by mass Cyanoresin solution and 54 parts by mass of DMF were added to the dispersion and the mixture was dispersed for additional 20 minutes. The obtained dispersion was filtered through a nylon mesh of 50 μm in pore size and defoamed. The filtered dispersion was packed in a wide-mouthed bottle made of Teflon and dispersed on a rotational roller at 50 rpm for 24 hours. Then, an appropriate amount of DMF was added to give a dielectric particle dispersion having a viscosity of 0.5 Pa·s at 16° C. Immediately before coating, this dielectric particle dispersion was passed through a 0.66 μm filter (manufactured by ROKITECHNO).

| | |
|---|---|
| BT-8 | 280 parts by mass |
| Cyanoresin | 80 parts by mass |
| DMF | 25 parts by mass |

Next, the dielectric particle dispersion was applied to an aluminum base (thickness 80 μm, unevenness in thickness ±3 μm) by using a doctor blade coater provided with a bullnose knife with a clearance adjusted so as to give a dry thickness of 20. μm at a coating speed of 0.9 m/min. Next, it was dried in a drying unit in which the temperature was gradually elevated from 110 to 130° C. Thus, a dielectric layer was formed on the back electrode.

Next, a solution (concentration 30% by mass) was prepared by dissolving barium titanate (BT-8, average particle size 120 nm: manufactured by Cabot Speciality Chemicals) employed as dielectric particles and a Cyanoresin (an equivalent mixture of CR-S with CR-V: manufactured by SHIN-ETSU) employed as a binder in DMF and a red pigment having a light emission peak at a wavelength of 620 nm was also prepared. The following composition was packed in a wide-mouthed bottle made of Teflon and dispersed on a rotational roller at 50 rpm for 30 minutes. Then, 280 parts by mass of zirconia particles having an average particle size of 2 mm were added thereto and the resultant mixture was dispersed for additional 30 minutes.

The obtained dispersion was dispersed in a mix rotor (consisting of parallel multiple discs made of alumina) for 2 hours. The rotational speed was 500 rpm at the initiation and then gradually elevated to 2000 rpm as the dispersion proceeded. To prevent the evaporation of the solvent, the dispersion was maintained at about 20° C. by ice-cooling around the pot. After dispersing, 120 parts by mass of a 30% by mass Cyanoresin solution and 54 parts by mass of DMF were added to the dispersion and the mixture was dispersed for additional 20 minutes. The obtained dispersion was filtered through a nylon mesh of 50 μm in pore size and defoamed. The filtered dispersion was packed in a wide-mouthed bottle made of Teflon and dispersed on a rotational roller at 50 rpm for 24 hours. Then, an appropriate amount of DMF was added to give a dielectric particle dispersion having a viscosity of 0.5 Pa·s at 16° C. Immediately before coating, this dielectric particle dispersion was passed through a 0.66 μm filter (manufactured by ROKITECHNO).

| | |
|---|---|
| BT-8 | 280 parts by mass |
| Cyanoresin | 80 parts by mass |
| Red pigment | 17 parts by mass |
| DMF | 25 parts by mass |

Next, the dielectric particle dispersion was applied to an aluminum base (thickness 80 μm, unevenness in thickness ±3 μm) by using a doctor blade coater provided with a bullnose knife with a clearance adjusted so as to give a dry thickness of 10 μm at a coating speed of 0.9 m/min. Next, it was dried in a drying unit at 110° C. Thus, a pigment layer was formed on the back electrode.

To the dried dielectric layer, the coating solution containing the EL phosphor particles was applied with a doctor blade coater to give a dry thickness of 50 μm and dried at 120° C. Thus, a laminate composed of the back electrode, the dielectric layer and the phosphor layer was obtained. In Example 16, however, the phosphor layer was applied in such a manner as to give a dry thickness of 30 μm.

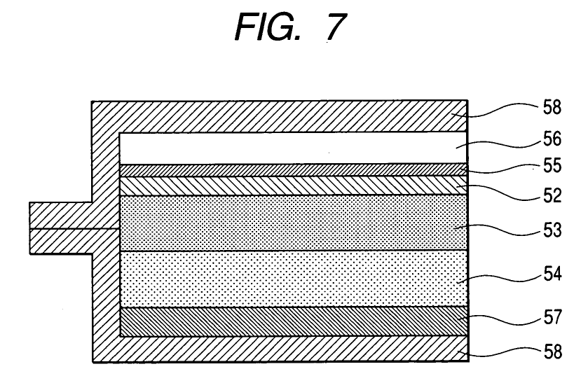

The phosphor layer of each laminate thus obtained was heat compression bonded to the transparent electrode film I or II with the use of a laminator at 190° C. The obtained laminate was cut into pieces in A4 size and leader electrodes were attached to the transparent electrode and the back electrode respectively. The whole laminate was sealed with a moisture-proof film to give an EL device. FIG. 7 shows the constitution of an EL device with the use of the transparent electrode film II.

[Evaluation of EL Devices]

An AC voltage of 1 kHz was applied on each EL device and the initial luminous efficiency and the brightness half-life in driving at the voltage so that the initial brightness was 300 cd/m² were measured. Table 2 shows the results. The brightness of the EL device was measured with a brightness meter (BMp: manufactured by TOPCON). The luminous efficiency was calculated by measuring the power consumption in driving the EL device with a Power Multimeter (7271; manufactured by NF KAIRO).

TABLE 2

| | | | | | | | | Light- | Light- | | |
|---|---|---|---|---|---|---|---|---|---|---|---|
| | | | | | | | | emission | emission | | |
| | | | | | | Half- | Half- | efficiency | efficiency | | |
| | EL phosphor | | | | Phosphor | life of | life of | of core | of coated | | |
| | | | ContiNuity | Transparent | Layer | core | coated | particles | particles | | Driving |
| Test | Coated | Core | In | electrode | thickness | particle | particle | (K₀) | (K₁) | | voltage |
| No. | particles | particles | coating | film | (μm) | (H₀) (h) | (H₁) (h) | (lm/W) | (lm/W) | K₁/K₀ | (V) |
| Ex. 1 | B | (B) | A | I | 50 | 750 | 1060 | 18.1 | 14.9 | 0.83 | 100 |
| 1-1 | B1 | (B1) | A | I | 50 | 590 | 850 | 18.6 | 15.5 | 0.83 | 90 |
| 1-2 | B2 | (B2) | A | I | 50 | 1000 | 1400 | 18.3 | 15.2 | 0.83 | 85 |
| 2 | C | (C) | A | I | 50 | 670 | 920 | 16.7 | 13.5 | 0.81 | 100 |
| 3 | D | (D) | A | I | 50 | 650 | 920 | 16.9 | 13.5 | 0.80 | 105 |
| 4 | E | (E) | A | I | 50 | 570 | 860 | 16.0 | 12.5 | 0.78 | 100 |
| 5 | F | (F) | A | I | 50 | 620 | 880 | 15.1 | 12.8 | 0.85 | 105 |
| 6 | H | (B) | A | I | 50 | 740 | 1000 | 18.1 | 15.0 | 0.83 | 100 |
| 7 | I | (B) | A | I | 50 | 740 | 1100 | 18.1 | 15.7 | 0.87 | 105 |
| 8 | J | (B) | A | I | 50 | 740 | 880 | 18.1 | 13.2 | 0.73 | 100 |
| 9 | K | (B) | B | I | 50 | 740 | 920 | 18.1 | 13.6 | 0.75 | 95 |
| 10 | L | (B) | A | I | 50 | 740 | 950 | 18.1 | 11.8 | 0.65 | 100 |
| 11 | M | (B) | B | I | 50 | 740 | 840 | 18.1 | 15.0 | 0.83 | 95 |
| 12 | N | (B) | B | I | 50 | 740 | 870 | 18.1 | 15.6 | 0.86 | 95 |
| 13 | O | (B) | B | I | 50 | 740 | 810 | 18.1 | 13.4 | 0.74 | 100 |
| 14 | B | (B) | A | II | 50 | 740 | 1200 | 18.1 | 14.8 | 0.82 | 105 |
| 15 | K | (B) | B | II | 50 | 740 | 1250 | 18.1 | 13.0 | 0.72 | 100 |
| 16 | B | (B) | A | I | 30 | 670 | 950 | 15.8 | 12.9 | 0.83 | 90 |
| 17 | B′ | (B′) | A | I | 50 | 520 | 730 | 17.5 | 14.5 | 0.83 | 100 |
| 18 | B″ | (B″) | A | I | 50 | 640 | 770 | 10.3 | 8.6 | 0.83 | 120 |
| 19 | b | (B) | B | I | 50 | 750 | 760 | 18.1 | 15.2 | 0.84 | 100 |
| C. | A | (A) | A | I | 50 | 490 | 700 | 8.8 | 5.4 | 0.61 | 125 |
| Ex. 1 | | | | | | | | | | | |
| C. | G | (G) | A | I | 50 | 240 | 300 | 4.5 | 2.7 | 0.60 | 140 |
| Ex. 2 | | | | | | | | | | | |

As described above, it can be understood that the EL devices using the coated EL phosphor particles of the invention (Examples 1 to 19) showed high luminous efficiencies and remarkably lowered luminous efficiency changes (K₁/K₀) due to the coating layer formation compared with the Comparative Examples 1 and 2.

These results indicate that the relative luminous efficiencies were remarkably elevated in the embodiment of the invention. It is also understood that the above effect became remarkable by selecting an appropriate particle size, coating the phosphor particles, gold-doping and platinum-doping. It is furthermore understood that the above effect could be further improved by selecting such a phosphor layer thickness as elevating the luminous efficiency.

Compared with the comparative samples, the EL devices of Examples of the invention required less voltage for light-emission at the same brightness, indicating that a high luminous efficiency and a high brightness were both established.

In the EL devices using the coated EL phosphor particles of the invention (Examples 1 to 19), the brightness half-life could be prolonged compared with the cases using uncoated EL phosphors (comparison of H₀ and H₁), thereby achieving practically efficacious lives.

From the results of Examples 14 and 15, it can be also understood that the effect of prolonging the brightness half-life could be synergistically elevated by introducing an intermediate layer. By comparing the results of Examples 1 and 14 and the results of Examples 9 and 15, it can be understood that a higher synergistic effect could be achieved by using a coating layer having less sufficient barrier properties. Furthermore, blackening in the EL device was lessened, compared with the uncoated EL phosphors, by combining the intermediate layer with the coated EL phosphor particles, though this phenomenon is not shown by the numerical data of the brightness half-life. In the case of a coating layer having a poor continuity, the ion-barrier properties are to be improved and the combined use with an intermediate layer is effective therefor.

Moreover, the results of Examples 17 to 19 indicate that the coated particles were highly durable in the case where the Au content and the average thickness of the coating layer were within the appropriate scopes as defined in the invention.

The EL devices of the invention had smaller particles and smaller coefficients of variation in the particle size distribution compared with the EL device of Comparative Example 2 and, therefore, showed very low coarseness (granularity) originating in the structural mottle.

This application is based on Japanese Patent application JP 2005-53415, filed Feb. 28, 2005, the entire content of which is hereby incorporated by reference, the same as if set forth at length.

What is claimed is:

1. An electroluminescent phosphor comprising: ZnS-based phosphor particles and a coating layer provided on a surface of the particle, wherein the particles have an average particle size of from 0.1 to 20 μm, and a coefficient of variation in a particle size distribution of less than 35%, and a content of particles having 10 or more stacking faults with an interplanar spacing of 5 nm or less is 30% or more based on all of the ZnS-based phosphor particles.

2. The electroluminescent phosphor as claimed in claim 1, wherein the average particle size of the particles is from 15 to 20 μm.

3. The electroluminescent phosphor as claimed in claim 1, wherein a ratio of an average thickness of the coating layer to the average particle size of the particles is from 0.001 to 0.1.

4. The electroluminescent phosphor as claimed in claim 1, wherein the ZnS-based phosphor particles contain at least one element selected from the group consisting of Cu, Mn, Ag and rare earth elements.

5. The electroluminescent phosphor as claimed in claim 1, wherein the ZnS-based phosphor particles contain at least one element selected from the group consisting of Cl, Br, I and Al.

6. The electroluminescent phosphor as claimed in claim 1, wherein the ZnS-based phosphor particles contain at least one element selected from the group consisting of Au, Sb, Bi, Cs and Pt.

7. The electroluminescent phosphor as claimed in claim 1, wherein the ZnS-based phosphor particles contain 1×10⁻⁷ to 5×10⁻⁴ mol of Au per mol of ZnS.

8. The electroluminescent phosphor as claimed in claim 1, wherein the ZnS-based phosphor particles contain 1×10⁻⁷ to 1×10⁻³ mol of Pt per mol of ZnS.

9. The electroluminescent phosphor as claimed in claim 1, wherein the coating layer contains at least one compound selected from the group consisting of oxides, nitrides, hydroxides, fluorides, phosphates, diamond carbon and organic compounds.

10. A method for producing an electroluminescent phosphor as claimed in claim 1, which comprises while fluidizing the ZnS-based phosphor particles in a presence of a fluidization promoter having a larger average particle size than the average particle size of the particles, supplying a material for making the coating layer thereto and piling up the material on a surface of the particles or reacting the material with the particles so as to form the coating layer.

11. A dispersion type electroluminescent device comprising: an opposing pair of electrodes at least one of which is transparent; a phosphor layer provided between the electrodes; and a dielectric layer provided between the electrodes, wherein the phosphor layer contains the electroluminescent phosphor as claimed in claim 1.

12. The dispersion type electroluminescent device as claimed in claim 11, wherein the phosphor layer has a thickness of from 40 to 100 μm.

13. The dispersion type electroluminescent device as claimed in claim 11, further comprising an intermediate layer provided between the transparent electrode and the phosphor layer.

14. The dispersion type electroluminescent device as claimed in claim 13, wherein the intermediate layer contains at least one of an organic polymer compound and an inorganic compound, and the intermediate layer has a thickness of from 10 nm to 100 μm.
